(19) United States
(12) Patent Application Publication
(10) Pub. No.: US 2016/0302980 A1
(43) Pub. Date: Oct. 20, 2016

(54) A STRETCHER WITH A MOBILE FOLDABLE CONSTRUCTION

(71) Applicant: NEZAMI AFRASHTEH, RAMOD REZA, Pruhonice (CZ)

(72) Inventor: Rambod Reza NEZAMI AFRASHTEH, Pruhonice (CZ)

(21) Appl. No.: 15/037,728

(22) PCT Filed: Nov. 19, 2014
(86) PCT No.: PCT/CZ2014/000136

§ 371 Date: May 19, 2016

(30) Foreign Application Priority Data
Nov. 19, 2013 (CZ) PV 2013-907

(51) Int. Cl. A61G 1/056; A61G 1/02

(52) U.S. Cl. CPC A61G 1/0562; A61G 1/0212

(57) ABSTRACT

A stretcher with a frame comprising girders rotatable front legs with a front connecting arm, rotatable rear legs with a rear connecting arm. The legs angularly adjustable by means of gas springs engaging the connecting arms. At least one gas spring is arranged in the frame between the longitudinal girders and does not extend beyond the outline of the longitudinal girders and the moving member of the gas spring is connected with a carrier slidably retained in at least one longitudinal girder. The carrier is connected by means of a strut pivotally retained at both its ends, with the front connecting arm or with the rear connecting arm or with at least one leg.

### FIELD OF THE INVENTION

The invention relates to the field of medical stretchers, more particularly to stretchers with a mobile foldable construction, the mobile foldable construction having the function of height regulation and of load position regulation.

### BACKGROUND OF THE ART

There are known stretchers to transport patients combined with a mobile foldable construction facilitating the medical staff to transport a patient, e.g. from an accident site in the ambulance. The mobile construction is height adjustable and to secure safe and comfortable loading the stretcher in an ambulance and its locking therein, it is produced as foldable. It is required that the mobile constructions formed by pairs of legs provided with castors allow folding all legs in one direction, rearwards, when loading the stretcher in the ambulance. Guiding castors are applied to manipulate the stretcher inside the ambulance. The guiding castors are attached to the frame both to its front portion and to its rear portion. Folding the legs represents the main problem in stretcher construction. The problem of the known stretchers from the prior art is the design of the way of folding the legs. The folding has to be continuous and gentle to spare the patient rough shocks and to spare the medical staff from carrying the whole weight of the patient when folding the stretcher. Locking of the mobile construction is commonly done by systems of mechanical springs and latches locking the foldable system.

U.S. Pat. No. 8,056,950 teaches safe folding of a mobile construction of a stretcher, The mobile construction is formed by two pairs of legs arranged in an “X” formation. The legs are in their lower portion joined by a lower rectangular frame, Both intersections of the “X” formation are mutually connected by an axis to which a piston of a hydraulic arm is attached. Its piston rod is connected to the front portion of the lower rectangular frame. The hydraulic arm controls folding and unfolding of the mobile construction. The flow the hydraulic liquid from a pump is controlled by en electric engine. This construction does not have the so-called roll in system, which means it does not allow for folding of the front legs in the direction of the rear legs for a simpler loading the stretcher in the ambulance. It is another drawback of the construction according to U.S. Pat. No. 8,056,950 that the whole mobile construction folds at one time, not independently of each other.

Document DE 36 31 409 describes a stretcher the mobile construction of which is formed by two pairs of front and rear legs, wherein the front and rear legs are not mutually connected and they are folded by a system of gas springs. The front legs are retained on the outer side of longitudinal girders forming the frame of the stretcher. The rear legs are retained on the inner side of the longitudinal girders so that they do not impede the front legs when being folded. The front and rear legs are folded independently of each other. The gas springs are retained under the frame of the stretcher, are connected with the crosspieces connected to the legs the folding of which they control. It is the drawback of this construction that the gas springs are connected directly to the legs so that the piston rods in the extended position suffer great stress even in directions concurrent with the axis of their motion. The working life of the piston rods is thus severely shortened. DE 36 31 409 solves this drawback by applying guiding rods among which the gas springs are placed. The guiding rods lessen the extra axial stress of the gas springs, however the extent of the gas springs is small. There is another drawback of the construction according to DE 36 31 409 in that the gas springs, beside the legs, represent other movable parts, being a safety risk for both the transported patient and for the staff in charge. Besides, the gas springs are controlled by levers, which can be easily unintentionally hit when manipulating the stretcher, which could cause the patient to fall or to suffer rough shocks. The stretcher has a roll in system to load in an ambulance, i.e. load position, when the gas spring folds the front legs and folds them in the direction of the rear legs. This folding is done by means of a strut connected to the piston rod of a gas spring. The drawback is the extra axial stress on the piston rod resulting in the gas spring being faster worn out.

It is an object of the present invention to provide a stretcher disposing of independent folding of the pairs of legs by means of gas springs and with the roll in function, the stretcher thus removing the drawbacks of the above cited constructions of stretchers; the operation and reliability of the stretcher would thus be improved as well as its folding, lowering and full elimination of extra axial stress, thus increasing their safety.

### SUMMARY OF THE INVENTION

This object is achieved by creating a stretcher with a mobile foldable construction according to this invention. The stretcher with a mobile foldable construction comprises a frame formed by two parallel longitudinal girders mutually connected at both their ends by cross beams. The frame is provided with castors and with a mobile foldable construction mounted to the frame. The mobile foldable construction is formed by a pair of front legs mutually connected by a front connecting arm and provided with front castors. The front legs are mounted on the front pivot axis with possibility of pivotal movement relative to the frame. The frame is further provided by a pair of rear legs mutually connected by a rear connecting arm. The rear legs are provided with rear castors and mounted on the rear pivot axis with possibility of pivotal movement relative to the frame. The front legs and the rear leas are angularly adjustable relative to the frame by means of gas springs engaging the connecting arms and they are at the same time foldable in a loading position so that they lie parallelly with the frame. The front legs and the rear legs are directed in the loading position to the rear end of the frame. It is the subject matter of the invention that at least one gas spring is arranged in the frame between the longitudinal girders and parallel therewith and does not extend beyond the outline of the longitudinal girders. The moving member of the gas spring is connected with a carrier slidably retained in at least one longitudinal girder. The carrier is connected by means of a strut pivotally retained at both its ends, with the front connecting arm or with the rear connecting arm or with at least one leg. It is an advantage of the present invention that the moving member of each gas spring moves in the horizontal plane so that minimal stress on the gas spring occurs. Retaining the gas springs in the frame protects them against damage and there is no extra axial stress on them. Retaining in the frame proves also advantageous because there is no risk of injury of the patient or of the staff because getting in touch with the moving member is excluded.

The rear pivot axis of the rear legs has a fixed position relative to the frame and the moving member of the rear gas spring arranged in the rear portion of the frame engages by means of the first carrier and the rear strut with the rear connecting arm to control the angular adjustment of the pair of rear legs relative to the frame. The rear legs fold only to adjust the height of the stretcher, i. e. in the direction of the rear part of the frame. Therefore the rear pivot axis is fixed relative to the frame, it does not slide over the frame and only pivots in the lugs retaining it to facilitate the folding movement of the rear legs consisting of shifting the first carrier in the direction of rear part of the frame engaging by means of the rear strut the rear connecting arm of the rear legs.

In an advantageous embodiment the front pivot axis for pivoting the front legs is movable relative to the frame, wherein the moving member of the front gas spring arranged in the middle portion of the frame is connected with the second carrier to which the front pivot axis of the front legs is attached and the front connecting arm is by means of the front strut retained rotatable at its both ends connected with the third carrier connected with a motion element for folding the front legs in the loading position, slidably retained in the front portion of the frame, parallelly between the longitudinal girders wherein it does not extend beyond the outline of the longitudinal girders. The front pivot axis and the front pivot pin slide on the lower part of the longitudinal girders as they are slidably connected to the frame. This provides for the possibility of folding the front legs in the direction of the front part of the frame to adjust the height of the stretcher. The adjustment of the height of the stretcher is done by controlling the front gas spring generating thus the movement of the second carrier. The motion element controls by means of the third carrier folding of the front legs in the load position, i.e. folding the front legs in the direction of the rear part of the frame. When folded in the load position the front legs lie between the rear legs because the pitch of the rear legs is larger than the pitch of the front legs.

The motion element comprises a tension spring retained in a tube on which a sleeve is slidably arranged, provided with a locking member for connecting and disconnecting the sleeve with the tension spring, wherein the sleeve is connected with the third carrier. Releasing the tension spring causes the tension spring to contract whereby it draws the sleeve with the locking member with it towards the front part of the frame. The third carrier is coupled to the sleeve and is therefore carried with it due to the effect of the tension spring whereby the third carrier affects the front pivot pin. The third carrier draws the front pivot pin in the direction of the rear part of the frame thereby folding the front legs in the load position. The front pivot axis is relative to the frame fixed during the load position folding process.

It is advantageous that the carriers are provided with rollers rollingly arranged in the longitudinal girders. The rollers thereby move smoothly which simplifies operation of the stretcher.

It is also advantageous that the rollers of at least one carrier are formed as a wheelset. Their motion is thus evenly spread and the shaped plated of the carriers does not deform.

In one advantageous embodiment both longitudinal girders are formed as a U profile and in another embodiment as C profile. The girders thus form guiding in which the rollers of the carriers roll. Due to the pitch of the shaped plates of the carriers the rollers cannot slide from the girders, securing thus safe operation of the stretcher.

The piston rod of the rear gas spring is fixedly attached to the rear cross beam and the piston rod of the front gas spring is fixedly attached to the base attached transversely between the longitudinal girders. The piston rods are the fixed elements of the gas springs. The cylinder is the moving member of the gas spring. By fixedly attaching the piston rods to the rear cross beam, the base respectively, they form a fixed central axis of the gas spring, the cylinder of which makes the sliding motion.

It is advantageous that the moving member of the rear gas spring and of the front gas spring is a cylinder. The carrier is a shaped plate provided with a sleeve in which the cylinder is inserted. The cylinder slides on the piston rod of the gas spring and carries the carrier the shaped plate of which is provided with rollers. The piston rod together with the longitudinal girders form guiding for both carriers to prevent deformation of the carriers.

There is a central crossbar in the middle portion of the frame dividing the frame in a front portion and in a rear portion. The central crossbar reinforces the frame.

The cylinder of the front gas spring is retained slidably in the central crossbar, wherein the piston rod and the base of the front gas spring are retained in the rear portion of the frame and the second carrier is retained in the front portion of the frame. This arrangement is caused by the transposition of the front pivot axis in relation to the front pivot pin. There is an aperture in the central crossbar allowing the cylinder of the front gas spring to slide on the piston rod. The piston rod of the rear gas spring is fixed to the rear cross beam and the cylinder of the rear gas spring is retained slidably in the base of the front gas spring. The cylinder of the rear gas spring can perform the sliding motion on the piston rod whereby it carries the first carrier drawing with it the rear pivot pin.

It is also advantageous that the third carrier is retained slidably between the longitudinal girders in the front part of the frame. There are plastic or rubber stops in the longitudinal girders to prevent the rollers of the third carrier to bump in the front cross beam. The plastic or rubber stops stop the rollers before the front cross beam.

In an advantageous embodiment there is a locking rod retained in the frame in parallel with the longitudinal girders, the locking rod being provided with at least one locking pen. The locking pen engages in the lock for locking at least one gas spring and/or a moving member. The lock is connected with the sleeve of the front gas spring and/or with the sleeve of the motion element. Folding front and rear legs is blocked by the locking pens. The folding can be only carried out after unlocking the locking pens. Uncontrolled folding of the legs is thus prevented.

The front pivot axis, the front pivot pin and the rear pivot pin are provided with sliding rollers for a rolling motion of the front pivot axis and of the front and rear pivot pins on the lower part of the longitudinal girders. The rollers secure a smooth motion of the front pivot axis and of the front and rear pivot pins when moving along the frame. The folding of the front and rear legs is thus smooth and continuous without bumps.

The longitudinal girders are provided with at least one catch for attaching the cot part of the stretcher. The cot part can be detached from the frame when needed.

The rear cross beam is provided with at least one rear handle and the front cross beam is provided with a front handle. There is a control element of the gas springs, a control element of the tension spring and a control element of the locking rod arranged in the handle. From each side of the stretcher it is possible to control the height adjustment of the front and rear legs. Folding of the front and rear legs can be controlled by the rear handle. Loading the stretcher in the ambulance can be controlled by only one member the medical staff.

The advantages of the stretcher with a mobile foldable construction according to the invention consist in the possibility of independent folding of the pair of the front legs and of the pair of the rear legs, wherein the pair of the front legs can be folded in a load position, i.e. in the direction to the rear part of the frame. The invention solves the problem of extra axial stress on the gas springs propelling the folding mechanism, securing thus long life and safety in use of the stretcher.

### DESCRIPTION OF THE DRAWINGS

The invention shall be disclosed in more detail by means of the drawings where the drawings show:

FIG. 1 a perspective view of the stretcher with a mobile foldable construction

FIG. 2 an upper view on the frame of the stretcher

FIG. 3 a lower view on the frame of the stretcher

FIG. 4 a perspective view on the mobile foldable construction

FIG. 5 a cross section of the set of the wheelset, lock and cylinder of the gas spring

FIG. 6 a cross section of the rear pivot pin, wheelset and gas spring

FIG. 7 a cross section of the rear pivot axis and of the central crossbar

FIG. 8 a cross section of the front pivot pin, first carrier, lock and motion element

FIG. 9 a perspective lower view of the mobile foldable construction

FIG. 10 a perspective view on the front part of the mobile foldable construction

FIG. 11 a perspective view on the rear part of the mobile foldable construction

FIG. 12 an exploded view of the rear lock

FIG. 13 an exploded view of the front lock

FIG. 14 an upper view on the motion element

FIG. 15 a cross section of the motion element

FIG. 16 an exploded view of the handle

FIG. 17 a detail of the motion element

FIG. 18 a detail of the rear lock, locking rod and the construction of the rear carrier

### DETAILED DESCRIPTION OF THE PREFERRED EMBODIMENT

It should be understood that the hereinafter described and illustrated specific examples of the realization of the invention are presented for illustrative purposes and not as a limitation of the examples of the realization of the invention to the cases shown herein. Experts who are familiar with the state of technology shall find, or using routine experimentation will be able to determine, a greater or lesser number of equivalents to the specific realizations of the invention which are specifically described here. These equivalents shall also be included into the scope of the claims.

The stretcher 1 with a mobile foldable construction 2 according to the invention consists of a frame 3 on which a cot part with a transported patient is mounted and of a mobile foldable construction 2 consisting of a pair of front legs 6 and of a pair of rear legs 7. The pair of the front and rear legs is provided with castors, not shown in the drawings, for simple transportation of the stretcher 1. The pairs of the front and rear legs 6, 7 can be folded in order to adjust the height according to the needs of the medical staff. Besides, the pair of the front legs 7 has a so-called. load position where the front legs are folded in order to allow a safe loading of the stretcher 1 with the patient in an ambulance. The pitch of the pair of the rear legs 7 is smaller than the pitch of the pair of the front legs 6. When the front legs 6 are folded in the load position, the rear legs 7 lie between the front legs 6. The front and rear legs 6, 7 are made from metal tubes with a surface treatment.

The pair of front legs 6 is connected by a front connecting arm 9. The front legs 6 thus form a unit and can be controlled simultaneously. The front connecting arm 9 is retained in a rotary manner between the front legs in a sleeve 40. A front strut 21 is connected with the front connecting arm 9. The connection is formed by means of a rotary sleeve 41 of the front strut 21. The front connecting arm 9 thus rotates in dependence of the folding of the front legs 6 and on the action of the front strut 21. There are two front struts 21 connected to the front connecting arm 9 to spread evenly the force of their action on the front connecting arm 9. The front struts 21 are by means of a sleeve 42 rotatably connected with the front pivot pin 36. The front pivot pin 36 is welded to the third carrier 25. Each front leg 6 is connected with the front pivot axis 21 connected by a rotary sleeve 44 allowing for the rotation of the front pivot axis 23. The front pivot axis 23 is welded to the second carrier 19.

The rear legs 7 are connected by a rear connecting arm 9′ so they form a unit like the front legs 6 and are controlled simultaneously. The rear connecting arm 9′ is between the rear legs 7 retained by a sleeve 46. When the rear legs 7 are being folded the rear connecting arm 9′ can rotate. A pair of rear struts 20 is coupled to the rear connecting arm 9′. The connection is formed by a rotary sleeve 47. The rear struts 20 are by means of rotary sleeves 48 connected with the rear pivot pin 37 welded to the first carrier 18. The pair of the rear legs 7 is by means of a rotary sleeve 50 connected to the rear pivot axis 22 in a rotary manner. The rear pivot axis 22 is retained in lugs 39 welded to the lower part of the frame 3 parallel with the central crossbar 29.

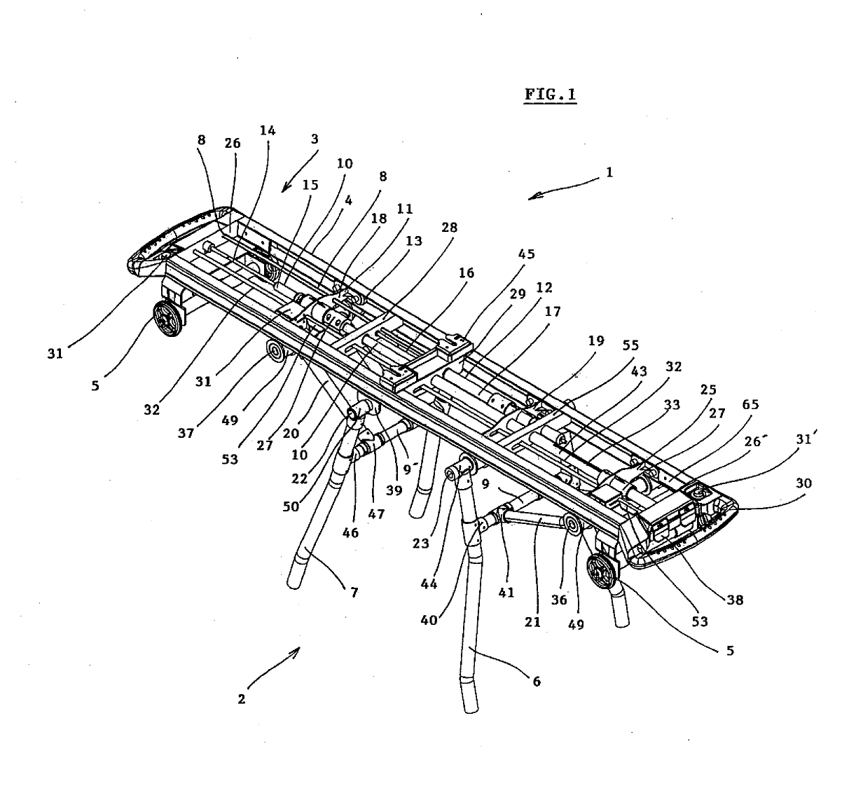

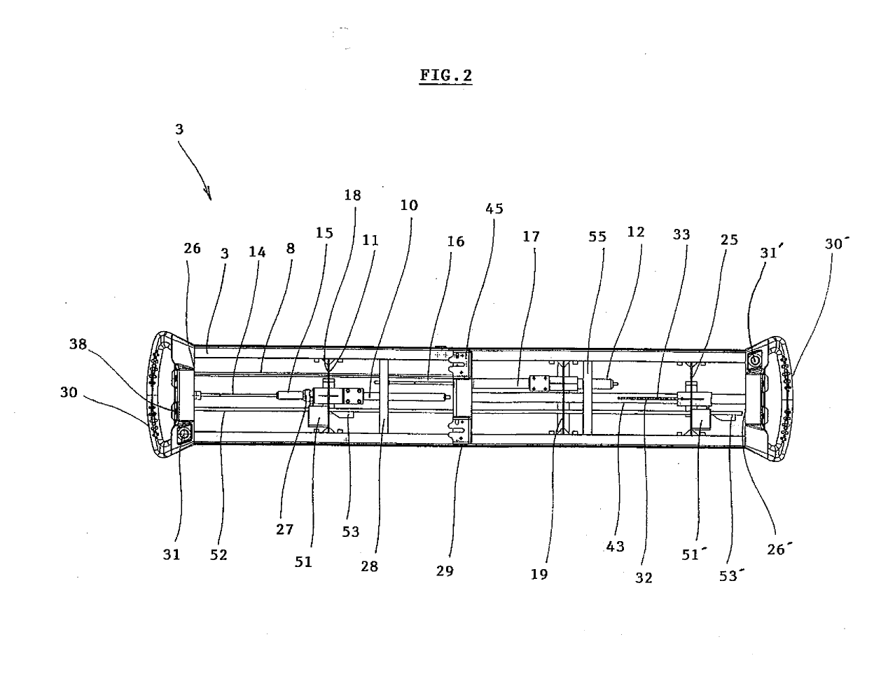

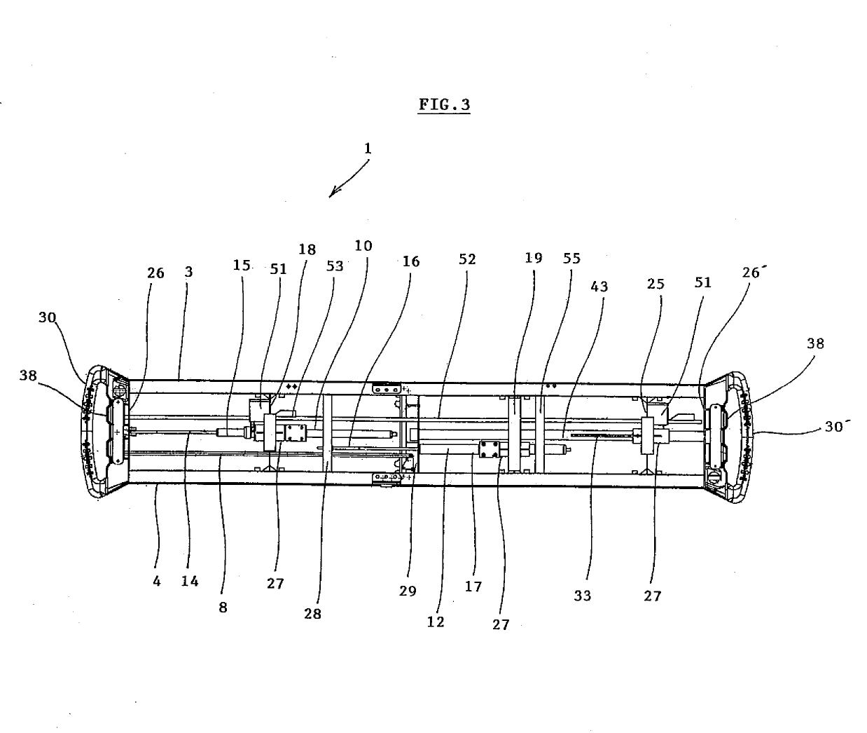

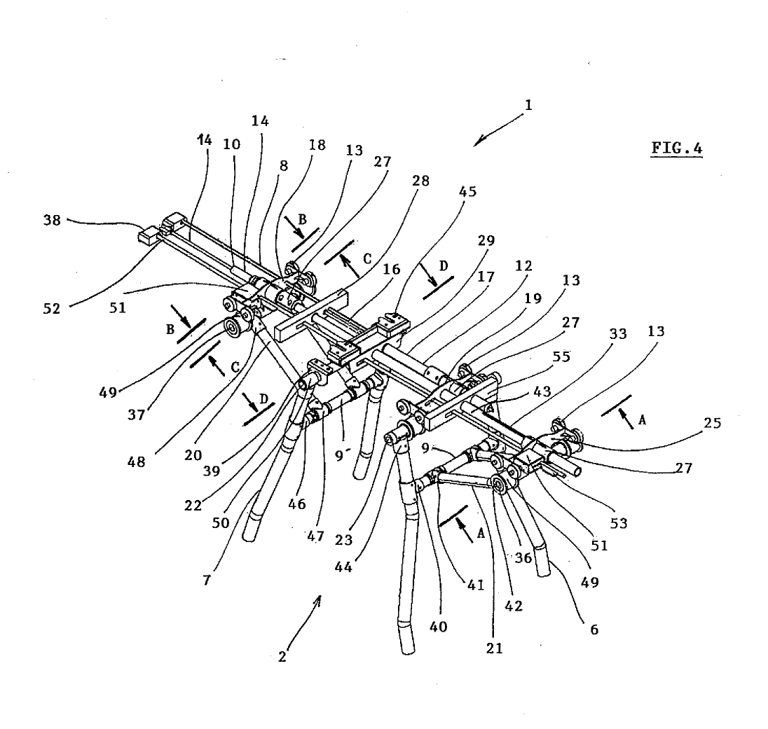

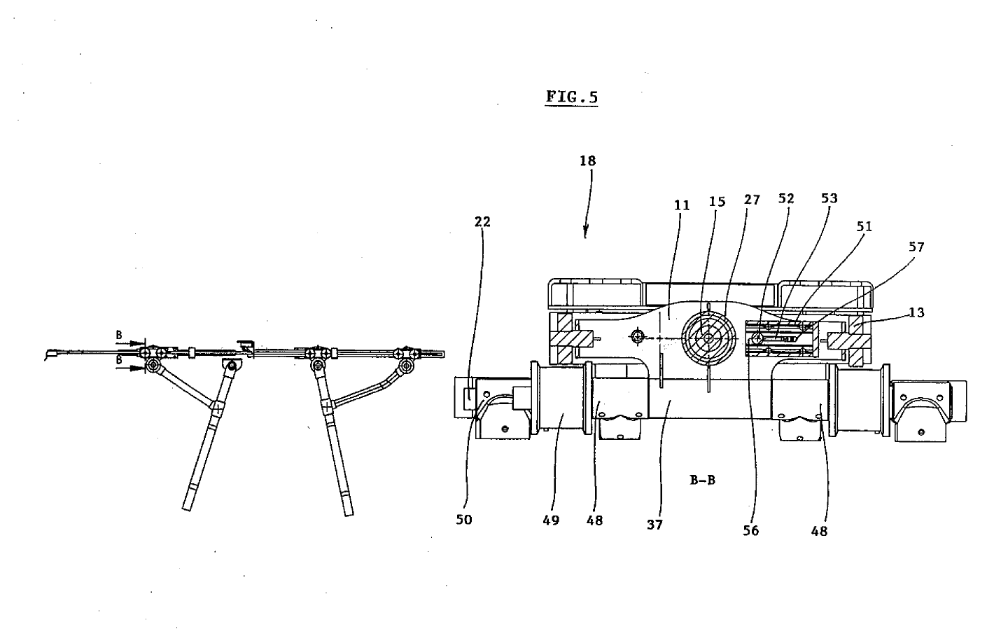

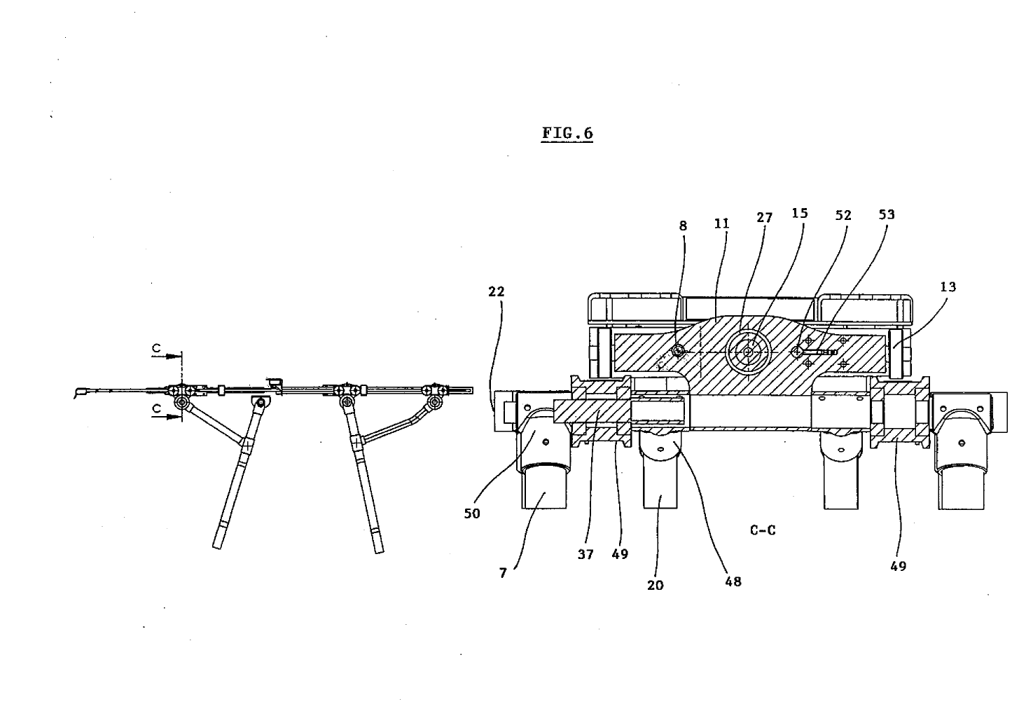

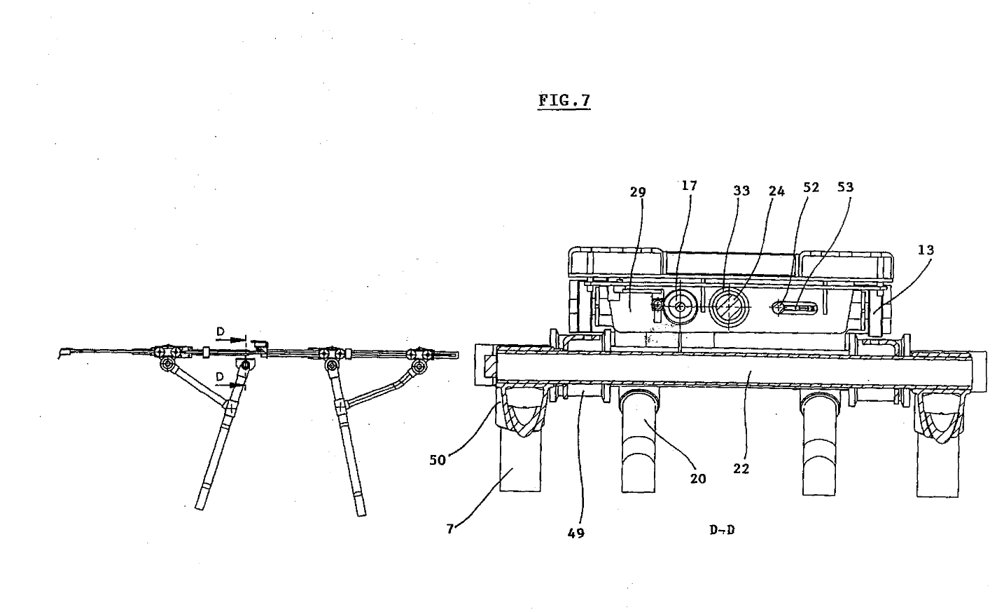

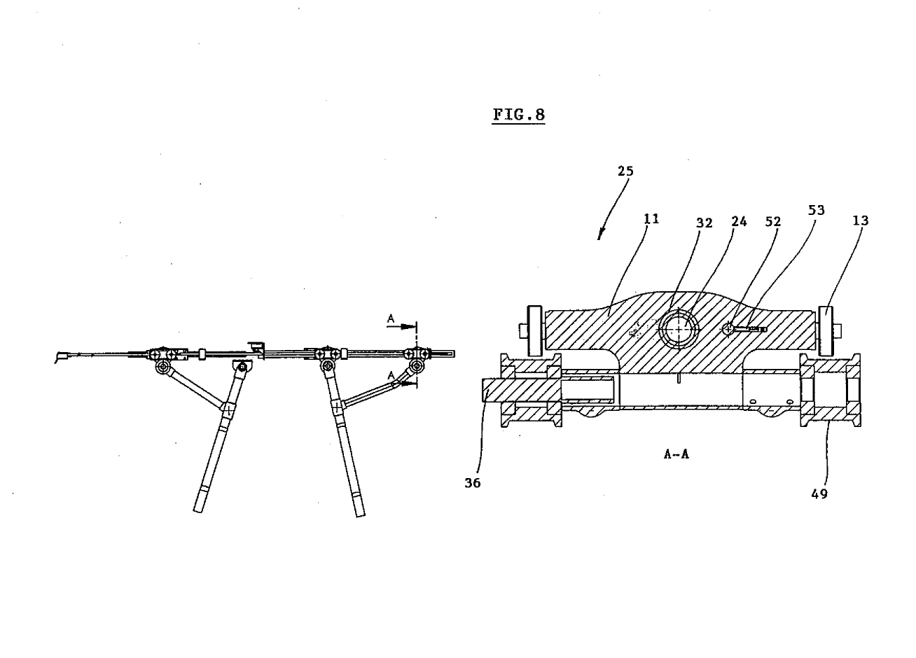

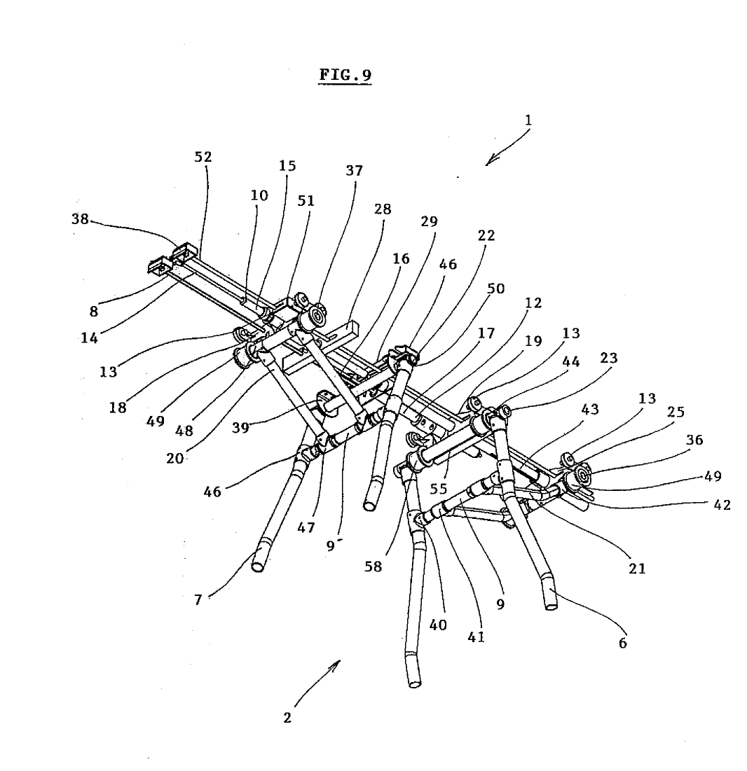

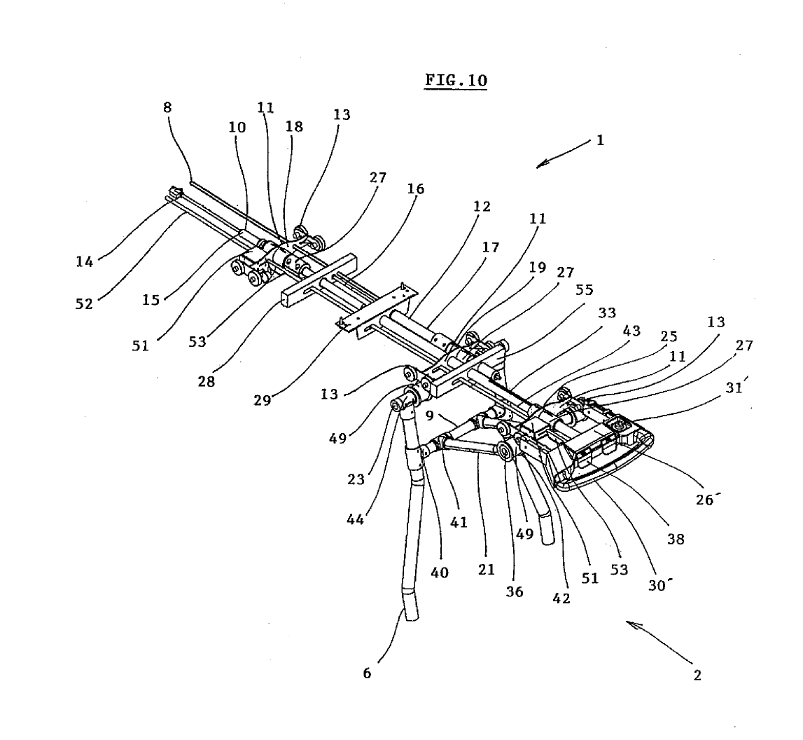

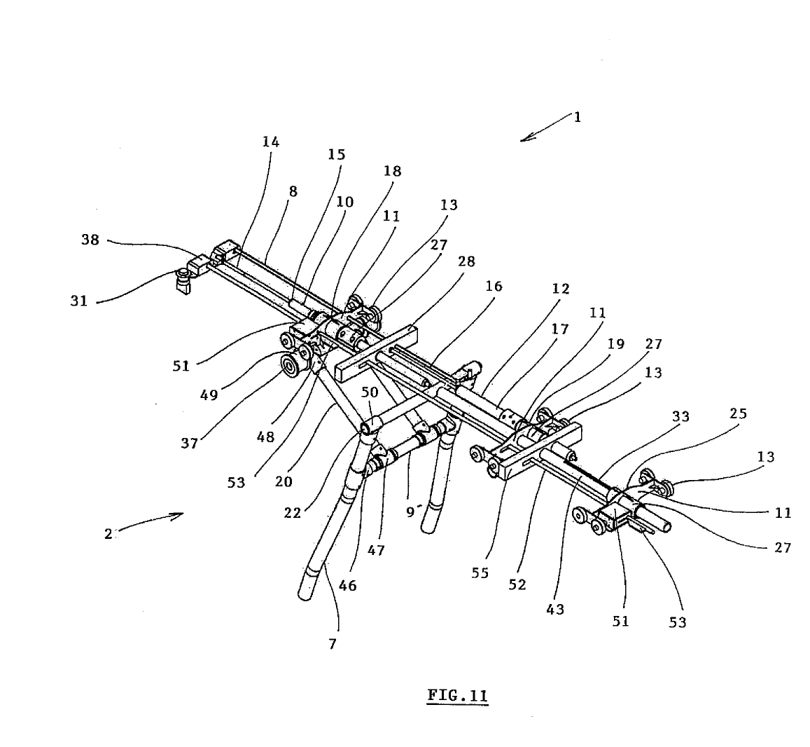

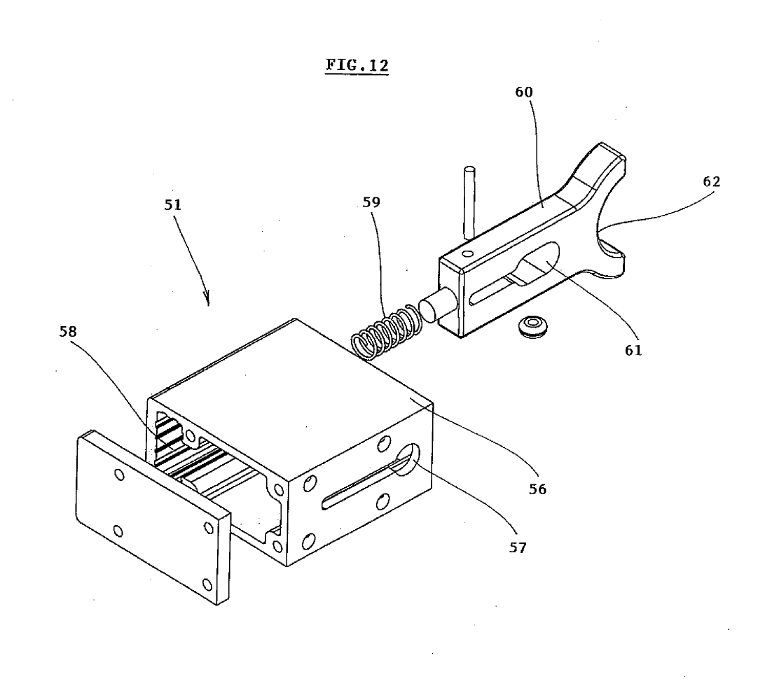

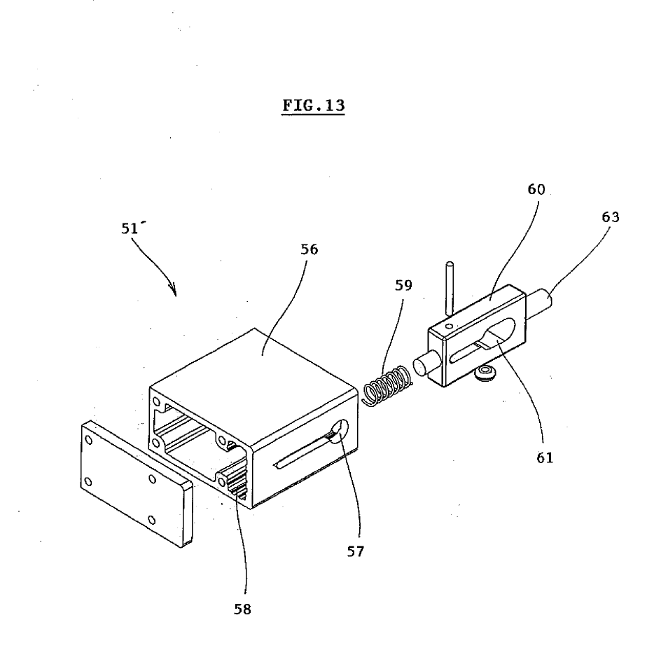

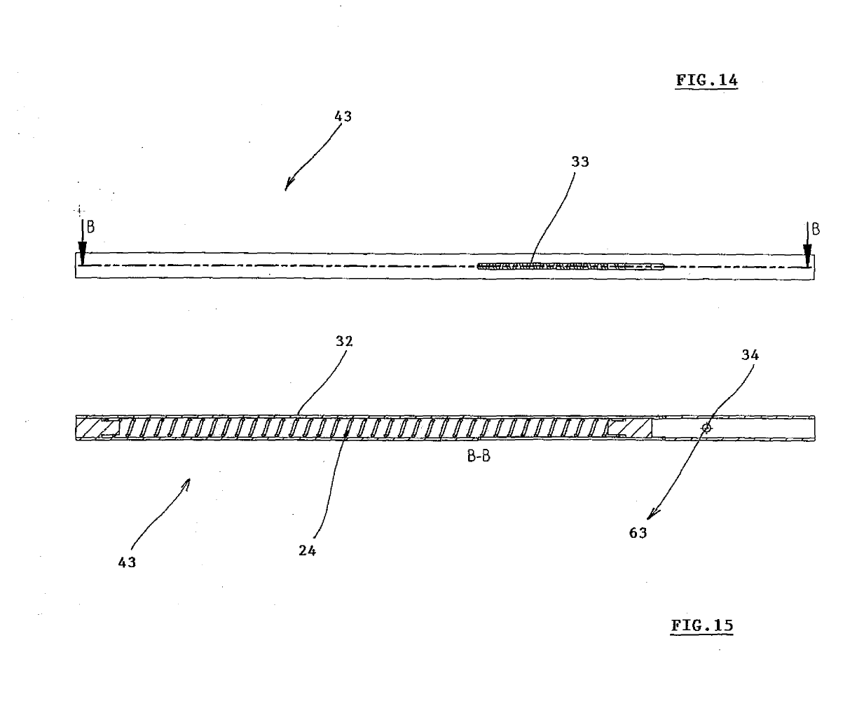

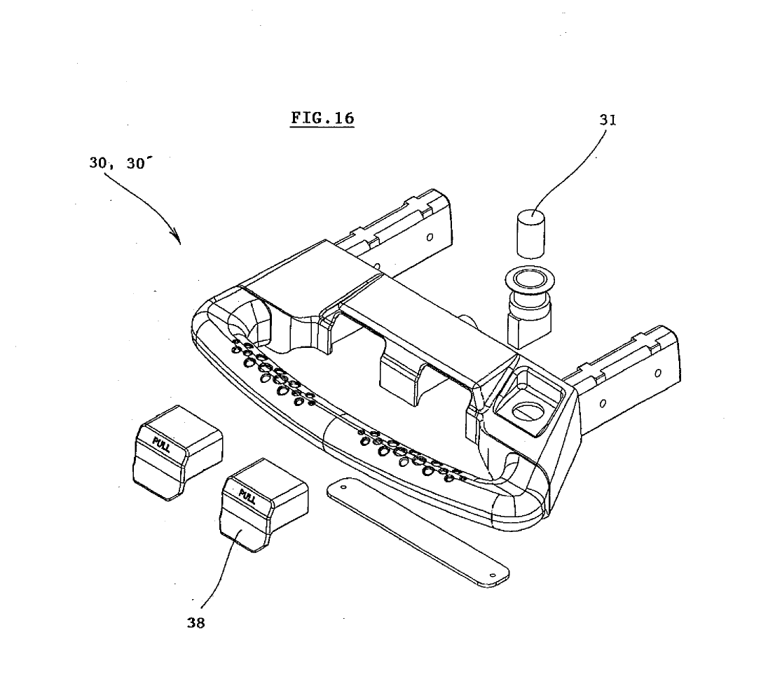

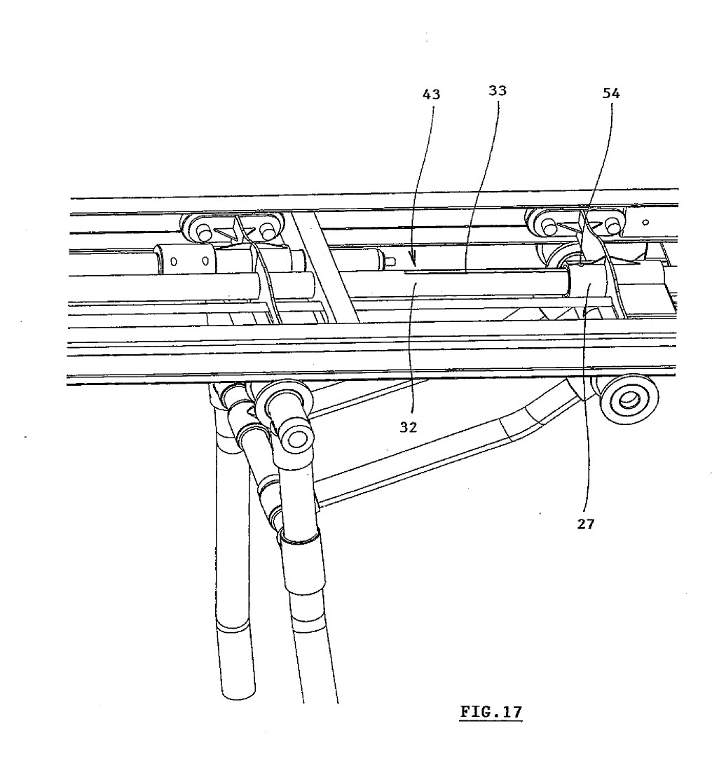

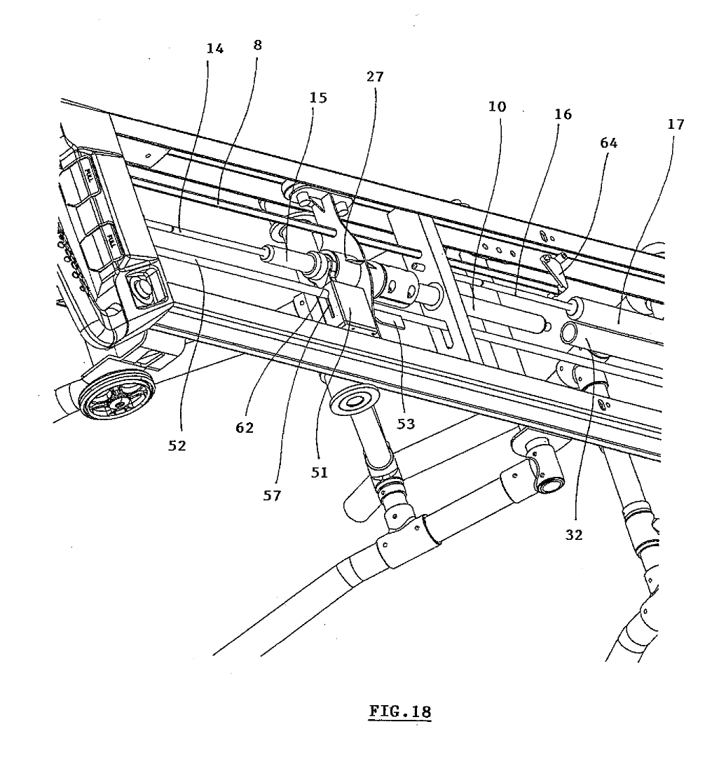

The frame 3 of the stretcher 1 is formed by two parallel longitudinal girders 4 from a metal material with a surface treatment. The metal girders 4 are formed in the shape of U or C profile. The frame 3 is provided with castors 5 on the ends of the girders 4. After folding the front and rear legs 6, 7, the castors 5 roll in the guiding rails inside the ambulance. The front parts of the longitudinal girders 4 are connected by a front cross beam 26′ and the rear ends of the longitudinal girders 4 are connected by a rear cross beam 26. In the embodiment shown in FIGS. 1 to 18 the front cross beam 26′ is an integra 26 part of the front handle 30′ and the rear cross beam 26 is an integral part of the rear handle 30. In the central part of the frame 3 a central crossbar 29 is arranged to reinforce the frame 3.

The pair of the front legs 6 is connected to the lower part of the frame 3 by a front pivot axis 23 the position of which is movable relative to the frame 3. i.e. this position changes by nearing and receding of the front pivot axis 23 relative to the front cross beam 26′. The front legs 6 fold along the front pivot axis 23 from their vertical position to a horizontal position in the direction to the front part of the frame 3. This direction of folding the front legs 6 causes lowering of the height of the stretcher 1. Folding in opposite direction increases the height of the stretcher 1. The front legs 6 can also be folded in the so-called load position when the front legs 6 are folded in the direction to the rear part of the frame 3. The front legs 6 are folded in the load position along the front pivot pin 36, while the front pivot axis 23 remains fixed.

The rear legs 7 fold only in the direction to the rear part of the frame 3 along the rear pivot axis 22. The folding is controlled by a rear pivot pin 37 coupled to the first carrier 18. Adjustment of the height of the folding is controlled by rear pivot pin 37 nearing and receding the rear cross beam 26.

The height of the pair of the rear legs 7 is adjusted by action of the rear gas spring 10 the whole of which is arranged in the rear part of the frame 3. The piston rod 14 of the rear gas spring 10 is coupled to rear cross beam 26. The moving member of the rear gas spring 10 is a cylinder 15 connected with the first carrier 18, travelling in the direction of the rear cross beam 26, i.e. in the direction of the rear part of the frame 3. The first carrier 18 is coupled with the rear pivot pin 37 connected by means of the rear strut 20 with the rear connecting arm 9′. The rear connecting arm 9′ couples the pair of the rear legs 7. The coupling with the rear strut 20 is rotary so that the rear connecting arm 9′ can rotate according to the position of the rear strut 20. The motion of the first carrier 18 moves the rear pivot pin 37 in the rear part of the frame 3, thereby drawing the rear legs 7 so that they are tightly fitted to the lower part of the frame 3 in their lowest position. The stretcher 1 in such case rolls on the castors 5. The rear pivot pin 22 is in a constant position relative to the frame 3. In the embodiment it is retained in lugs 39 parallel with the central crossbar 29. The rear gas spring 10 is controlled by control means, e.g. a Bowden cable, same as the front gas spring 12. The control means of the front and rear gas springs 12, 10 can be any means known to those skilled in the art. The control element 31 of the control means of the rear gas spring 10 is placed in the rear handle 30. The motion of the cylinder 15 of the rear gas spring 10 towards the front part of the frame 3 causes the rear strut 20 to push on the rear connecting arm 9′ pushing thereby the pair of rear legs 7 in a vertical position. The height of the stretcher 1 is thus increased. The rear pivot pin 37 is in the area where it abuts the longitudinal girders 4 provided by sliding rollers 49 making the rolling motion of the rear pivot pin 37 along the longitudinal girders 4 easier. In the rear handle 30 there is also placed the control means of the tension spring 24 and the control element 38 of the locking rod 52. Folding of the front legs 6 in load position can be controlled from the rear part of the frame 3.

In the front part of the frame 3 there is mounted the front gas spring 12 the piston rod 16 of which is fitted to the base 28 in the rear part of the frame 3. The base 28 is welded or screwed to the longitudinal girders 4. The base 28 is made as a solid metal profile welded to the longitudinal girders 4. The piston rod 16 in this embodiment is the fixed member of the front gas spring 12. The moving member is the cylinder 17. The cylinder 17 of the front gas spring 12 is mounted in the frame 3 with possibility of movement so that when moving it extends in the rear and in the front part of the frame 3 whereby it passes through the central crossbar 29. The second carrier 19 is attached to the cylinder 17 of the front gas spring 12. The second carrier 19 is carried by the cylinder 17 and it is guided between the longitudinal girders 4 in a sliding manner. The front pivot axis 23 is attached to the second carrier 19. The front gas spring 12 is controlled by a control member, the control element 31′ is arranged in the handle 30 in the front part of the stretcher 1. The second carrier 19 after pushing the control element 31′ travels between the longitudinal girders 4 towards the central crossbar 29 stopping the second carrier 19. The second carrier 19 carries the front pivot axis 23 towards the rear part of the frame 3 folding thereby the pair of front legs 6 along the front connecting arm 9 in the direction to the front part of the frame 3. This folding direction lowers the height of the stretcher 1 because the position of the front connecting arm 9 does not change in the course of folding and forms the revolving axis of the front legs 6. When the second carrier 19 moves towards the front part of the frame 3 the front legs 6 pivot around the same axis but in the opposite direction, i.e. the front legs 6 are positioned in the vertical position and the height of the stretcher 1 increases. The front pivot axis 23 and the front pivot pin 36 are in the area abutting the longitudinal girders 4 provided with sliding rollers 49 to make smooth their rolling movement along the longitudinal girders 4. During folding the front legs 6 by means of the front gas spring 12 the front pivot pin 36 moves towards the rear part of the frame 3.

The front legs 6 can be folded in load position to simplify loading the stretcher 1 in an ambulance. In the load position the front legs 6 are folded in the direction of the rear part of the frame 3 so that they lie parallel with the frame 3 between the rear legs 7 their pitch being larger than the pitch of the front legs 6. To manipulate the stretcher 1 the castors 5 are applied. Folding the front legs 6 in load position is done by application of a motion element 43 formed by a tube 32 in which a tension spring 24 is retained. A locking member 34 is attached to the tension spring 24. The locking member 24 is welded to the sleeve 27 of the motion element 43. There is an elongate slot 33 made in the tube 32. When the front lock 51′ is released the locking pin 63 pulls out from the sleeve 27 of the motion element 43. The tension spring 24 draws the sleeve 27 of the motion element 43 along the whole length of the slot 33 in the direction of the rear part of the frame 3. The third carrier 25 is attached to the sleeve 27. The third carrier 25 carries the front pivot pin 36 in the direction of the rear part of the frame. The front pivot pin 36 pushes by the action of the pair of front struts 21 the front connecting arm 9 and thereby folds the pair of the front legs 6 around the front pivot axis 23 in a horizontal position towards the rear part of the frame 3. When folding the front legs 6 in the load position the front pivot axis 23 is fixed and the third carrier 25 is carried by the tension spring 24 through the slot 33 in the tube 32 to the level of the cylinder 17 of front gas spring 12.

The rear gas spring 10, the front gas spring 12 and the motion element 43 are arranged inside the frame parallel with the longitudinal girders 4.

The first carrier 18 comprises a shaped plate 11 transversely retained between the longitudinal girders 4. The shaped plate 11 is on both its ends provided by rollers 13. In this embodiment the rollers 13 are made as wheelsets. The rollers 13 travel between the longitudinal girders 4 in dependence on the motion of the cylinder 15 of the rear gas spring 10 The cylinder 15 of the rear gas spring 10 is attached to the shaped plate 11 by means of a sleeve 27. In this embodiment the attachment of the cylinder 15 of the rear gas spring 10, of the sleeve 27 and of the shaped plate 11 is made by welding.

The second carrier 19 and the third carrier 25 are made in the same manner. The shaped plate 11 of the third carrier 25 by means of the sleeve connected with the locking pin 63 of the motion element 43.

A locking rod 52 is arranged inside the frame 3 parallel with the longitudinal girders 4, rear gas spring 10, front gas spring 12 and the motion element 43. The locking rod 52 is in the frame 3 arranged so that it abuts the rear gas spring 10 and the motion element 43. The locking rod 52 is in the point of the shaped plate 11 of the first carrier 18 and the point of the shaped plate 11 of the third carrier 25 provided with a locking pen 53. The locking rod 52 is controlled by the push and pull movement of the control element 38 arranged in the front and rear handle 30, 30′.

The front lock 51 is fixed to the shaped plate 11 of the first carrier 18. By pulling the control element 38 of the locking rod 52 the rear locking pen 53 slips in the rear lock 51 and the locking rod 52 pulls away from the rear gas spring 10. Releasing the pressure of the locking rod 52 and of the rear locking pen 53 causes a locking block 60 to slip in releasing by its action the cylinder 15 of the rear gas spring 10, triggering thus the movement of the first carrier 18. The rear legs 7 can thus he folded in the load position for loading in the ambulance.

A front lock 51′ is attached to the shaped plate 11 of the third carrier 25. By pulling the control element 38 of the locking rod 52 the front locking pen 53 slips in the front lock 51′ and the locking rod 52 pulls away from the motion element 43. Releasing the pressure of the locking rod 52 and of the front locking pen 53 causes a locking block 60 to slip in, releasing by its action the locking pin 63 of the motion element 43 thereby triggering the movement of the third carrier 25. The front legs 6 can thus be folded to load position for the stretcher 1 to be loaded in the ambulance.

A locking rod 8 of a catch is fixed in the rear cross beam 26. The locking rod 8 passes through the first carrier 18, the base 28 of the rear gas spring 10 and is finished by a latch 64 in the central crossbar 29. The locking rod 8 controls by the latch 64 the locks 45 attaching the cot part (not shown in the figures) to the frame 3. The patient lies on the cot part.

The longitudinal girders 4 of the frame 3 are in this embodiment made as a U profile. In the area where the longitudinal girders 4 are coupled with the front cross beam 26′ and with the rear cross beam 26 there is a stop 65. The stop 65 in the front part of the frame 3 stops the rollers 13 of the third carrier 25 from bumping in the front cross beam 26. The stop 65 in the rear part of the frame 3 stops the rollers 13 of the first carrier 18 from bumping in the rear cross beam 26.

### INDUSTRIAL APPLICABILITY

The stretcher with a mobile foldable construction according to the invention can be applied in all medical services and establishments, particularly in mobile medical care services, as an equipment of ambulances, for emergency and rescue services such as mine rescue, mountain rescue, and air ambulance, fire and military emergency departments etc.

### LIST OF THE POSITIONS AND SYMBOLS USED IN THE DRAWING AND IN THE DESCRIPTION

1 stretcher

2 mobile foldable construction

3 frame

4 longitudinal girder

5 castor of the longitudinal girder

6 front leg

7 rear leg

8 locking rod of the catch

9 front connecting arm

9′ rear connecting arm

10 rear gas spring

11 shaped plate

12 front gas spring

13 roller

14 piston rod of the rear gas spring

15 cylinder of the rear gas spring

16 piston rod of the front gas spring

17 cylinder of the front gas spring

18 first carrier

19 second carrier

20 rear strut

21 front strut

22 rear pivot axis

23 front pivot axis

24 tension spring

25 third carrier

26 rear cross beam

26′ front cross beam

27 sleeve

28 base of the front gas spring

29 central crossbar

30 rear handle

30′ front handle

31 control element of the rear gas spring

31′ control element of the front gas spring

32 tube

33 slot

34 locking member

35

36 front pivot pin

37 rear pivot pin

38 control element of the locking rod

39 lug for retaining the rear pivot axis

40 sleeve of the front connecting arm

41 sleeve of the front strut

42 sleeve of the front pivot pin

43 motion element

44 sleeve of the front pivot axis

45 catch

46 sleeve of the rear connecting arm

47 sleeve of the rear strut

48 rotary sleeve of the rear pivot pin

49 sliding roller

50 sleeve of the rear pivot axis

51 rear lock

51′ front lock

52 locking rod

53 locking pen

54 locking pin of the tension spring

55 base of the motion element

56 case of the lock

57 locking slot

58 internal guideway

59 spring

60 locking block

61 shaped groove

62 locking recess

63 locking pin of the locking block

64 latch

65 stop

1. A stretcher with a mobile foldable construction comprising a frame formed by two parallel longitudinal girders mutually connected at both their ends by cross beams; the frame being provided by castors and by a mobile foldable construction mounted to the frame, the mobile foldable construction being formed by a pair of front legs mutually connected by a front connecting arm and provided with front castors, the front legs being mounted on the front pivot axis with possibility of pivotal movement relative to the frame the frame being further provided by a pair or rear legs mutually connected by a rear connecting arm, the rear legs being provided with rear castors and mounted on the rear pivot axis with possibility of pivotal movement relative to the frame wherein the front legs and the rear legs are angularly adjustable relative to the frame by means of gas springs engaging the connecting arms 44, and they are at the same time foldable in a loading position so that they lie parallelly with the frame, wherein the front legs and the rear legs are directed in the loading position to the rear end of the frame wherein at least one gas spring is arranged in the frame between the longitudinal girders and parallel therewith and does not extend beyond the outline of the longitudinal girders and the moving member of the gas spring is connected with a carrier slidably retained in at least one longitudinal girder, the carrier being connected, by means of a strut pivotally retained at both its ends, with the front connecting arm or with the rear connecting arm or with at least one leg.

2. The stretcher according to claim 1 wherein the rear pivot axis of the rear legs has a fixed position relative to the frame and the moving member of the rear gas spring arranged in the rear portion of the frame engages by means of the first carrier and the rear strut the rear connecting arm to control the angular adjustment of the pair of rear legs relative to the frame.

3. The stretcher according to claim 1 wherein the front pivot axis for pivoting the front legs is movable relative to the frame, wherein the moving member of the front gas spring arranged in the middle portion of the frame is connected with the second carrier to which the front pivot axis of the front legs is attached and the front connecting arm is by means of the front strut retained rotatably at its both ends connected with the third carrier connected with a motion element for folding the front legs in the loading position, slidably retained in the front portion of the frame, parallelly between the longitudinal girders wherein it does not extend beyond the outline of the longitudinal girders.

4. The stretcher according to claim 3 wherein the motion element comprises a tension spring retained in a tube on which a sleeve is slidably arranged, provided with a locking member for connecting and disconnecting of the sleeve with the tension spring, wherein the sleeve is connected with the third carrier.

5. The stretcher according to claim 1 wherein the carriers are provided with rollers rollingly arranged in the longitudinal girders.

6. The stretcher according to claim 5 wherein the rollers of at least one carrier are formed as a wheelset.

7. The stretcher according to claim 1 wherein both longitudinal girders are formed as a U profile.

8. The stretcher according to claim 1 wherein both longitudinal girders are formed as a C profile.

9. The stretcher according to claim 1 wherein the piston rod of the rear gas spring is fixedly attached to the rear cross beam and the piston rod of the front gas spring is fixedly attached to the base attached transversely between the longitudinal girders.

10. The stretcher according to claim 1 wherein the moving member of the rear gas spring and of the front gas spring is a cylinder.

11. The stretcher according to claim 10 wherein the carrier is formed by a shaped plate provided with a sleeve in which the cylinder is inserted.

12. The stretcher according to claim 1 wherein there is a central crossbar in the middle portion of the frame dividing the frame in a front portion and in a rear portion.

13. The stretcher according to claim 1 wherein the cylinder of the front gas spring is retained slidably in the central crossbar, wherein the piston rod and the base of the front gas spring are retained in the rear portion of the frame and the second carrier is retained in the front portion of the frame.

14. The stretcher according to claim 1 wherein the piston rod of the rear gas spring is fixed to the rear cross beam and the cylinder of the rear gas spring is retained slidably in the base of the front gas spring.

15. The stretcher according to claim 1 wherein the third carrier is retained slit between the longitudinal girders in the front part of the frame.

16. The stretcher according to claim 1 wherein there is a locking rod retained in the frame in parallel with the longitudinal girders, the locking rod being provided with at least one locking pen wherein the locking pen engages in the lock for locking at least one gas spring and/or a moving member.

17. The stretcher according to claim 16 wherein the lock is connected with the sleeve of the front gas spring and/or with the sleeve of the motion element.

18. The stretcher according to claim 1 wherein the front pivot axis, the front pivot pin and the rear pivot pin are provided with sliding rollers for a rolling motion of the front pivot axis and the front and rear pivot pins on the lower part of the longitudinal girders.

19. The stretcher according to claim 1 wherein the longitudinal girders are provided with at least one catch for attaching the cot part of the stretcher.

20. The stretcher according to claim 1 wherein the rear cross beam is provided with at least one rear handle and the front cross beam is provided with a front handle wherein there is a control element of the gas springs, a control element of the tension spring and a control element of the locking rod arranged in the handle.
